(19) United States
(12) Patent Application Publication
(10) Pub. No.: US 2005/0283264 A1
(43) Pub. Date: Dec. 22, 2005

(54) Method and system for automatically configuring an audio environment

(76) Inventor: Thomas Lemaigre du Breuil, Ivyland, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/214,534

(22) Filed: Aug. 29, 2005

Related U.S. Application Data
(62) Division of application No. 09/976,019, filed on Oct. 15, 2001.

(51) Int. Cl. G06F 17/00

(52) U.S. Cl. 700/94

(57) ABSTRACT

Audio reproduction in an advanced analog or digital cable/satellite television environment provides audio configuration information in a program guide that determines the parameters needed for optimum audio reproduction based on the audio source and the delivery channel. A control interface between the program guide and a user's audio electronics allows the specific capabilities of the audio electronics to be taken into account when optimizing audio reproduction. In one embodiment, the audio electronics are automatically responsive to the audio configuration information so that audio reproduction can be optimized can be optimized based on the information without requiring any action by the user.

This is a divisional application of U.S. application Ser. No. 09/976,019 filed on Oct. 15, 2001.

### BACKGROUND OF THE INVENTION

1. Field of the Invention

The present invention relates to audio systems, and more particularly to audio systems that can be configured to optimize audio signal output and sound reproduction regardless of the source of the audio signal.

2. Description of the Related Art

Technological trends in consumer audio equipment have created audio systems that are increasingly sophisticated and that produce sound quality that rivals professional-level systems. The increased popularity of home theatres, along with the advances provided by digital encoding of audio and video data, has fueled the demand for audio systems that can produce theatre-quality sound to accompany the high-resolution video provided by digital systems.

There is a need for a system that provides end users with optimal audio output for any combination of audio encoding format, delivery channel, and sound system based on the capabilities of the end user's specific equipment and personal preferences.

### SUMMARY OF THE INVENTION

The present invention is directed to a method and system for automatically configuring a user's listening environment for optimal sound reproduction based on the characteristics of the specific audio signal being transmitted and the specific service the user is listening and possibly also watching.

### BRIEF DESCRIPTION OF THE DRAWINGS

FIG. 1 is a block diagram illustrating one embodiment of the inventive system; and

FIG. 2 is a block diagram illustrating another embodiment of the inventive system

### DESCRIPTION OF THE PREFERRED EMBODIMENTS

The invention is directed to providing both data and control mechanisms for enabling automated optimization of a listening environment. The invention covers two aspects that provide the necessary automation: providing control data (e.g., configuration information) and automating the control.

One manner in which sound quality can be improved is through multiple channels, first offered via analog technologies such as Dolby Stereo® and Dolby Surround® and later offered through advanced digital audio encoding schemes that use multiple channels. Examples of such audio encoding schemes include MPEG-2 Audio, Dolby Digital® and dts®. Using Dolby Digital® as an example, an audio signal that is created and encoded for output via multiple discrete full-range channels would require discrete multi-channel audio reproduction equipment for optimum sound reproduction. If the user does not have multi-channel equipment, it is possible to either deliver the sound through a less than optimal playback system (e.g., via a four channel system rather than a six channel system), at some sacrifice to the intended sound quality of the original audio signal, by conforming the original signal to the parameters of the available playback system. Some playback systems allow the user to adjust the playback parameters manually to adapt to different audio encoding schemes if the user knows the scheme that was used to generate and encode the data. To further optimize audio reproduction, the user should also be aware of the delivery mechanism used between the audio signal source and the user's playback system so that the user can conduct further configuration for optimizing the audio output.

As the number and types of multi-channel sound systems has increased, the number of permutations and combinations of audio encoding formats, sound systems and delivery channels has also increased to the point where manual configuration becomes relatively complex. Although there have been attempts by audio equipment manufacturers to provide sufficient information for users to configure their audio equipment for optimal sound reproduction, this still requires the user to determine how the audio signals were produced and transmitted and, with this information, configure their audio electronic equipment via any number of controls to reproduce the audio signals properly. This requires users to conduct their own research regarding both audio signal production and their audio equipment, which tends to be overly cumbersome for the average user even if that user is a critical listener. The user's own environment, and specifically the user's audio preferences, audio equipment reproduction capabilities and in-room speaker configuration can further complicate attempts to optimize audio reproduction. To further complicate the process, these configuration attempts assume that the audio signal information, such as information regarding the original audio encoding scheme, is even available to the user, which it often is not.

Audio encoding and transmission parameters can change from one program to another, from a program to a commercial (and vice versa), or from an analog radio, videocassette, or television program to a digital audio CD, digital television program, or DVD. However, failure to configure the listener's equipment to account for these variations will create less-than-optimal sound reproduction, a problem that can be particularly noticeable for critical listeners. Although some companies have attempted to address this problem by automatically configuring the listener's audio equipment to optimize sound reproduction for any given audio source, these systems are only able to conduct automatic configuration for a limited number of systems and tend to focus on limited portions of the audio system (e.g., solely on the audio encoding format) without taking into account the end-to-end characteristics of the entire audio delivery and reproduction system. This limited focus tends to compromise the sound quality that is ultimately output.

Although most digital carriers of audio information (e.g., CDs, DATs, DVDs, etc.) support data fields that contain audio production information and configuration information that can be used to configure the user's audio equipment in the most appropriate manner, there are currently no mechanisms that ensure that there is data in these fields at all or that the data is correct or maintained throughout the delivery channel into the user's environment so that the data reaches the audio equipment in the first place. Further, even if the data fields contain equipment configuration data, there is no mechanism for ensuring that the audio equipment respond to the configuration data in the data fields. Additionally, the focus on data fields in digital carriers provides no defined mechanism for instructing how downstream audio equipment should respond to the configuration data. Further, none of these schemes have the capability to define the audio parameters for analog recordings or distribution mechanisms.

Table 1 below illustrates examples of typical source creation and delivery channel combinations as well as the mechanism through which the best possible audio reproduction can be obtained. As can be seen in the Table, the system may provide the user with either no indication of the optimal system configuration or may even provide the wrong information. Further, in most cases, automatic configuration is available only in very limited circumstances where the source creation mechanism and delivery channel match, thereby making the determination of the optimal reproduction configuration relatively simple.

TABLE 1

| | DELIVERY | | Best Manual | Automatic |
|---|---|---|---|---|
| SOURCE | CHANNEL | Best Possible | Configuration | Configuration |
| CHARACTERISTIC | CAPABILITY | Reproduction | Indicated Today? | Defined Today? |
| Mono | Mono, Stereo, | Mono | Usually not | Sometimes |
| | Digital Dolby, etc. | | | |
| Stereo (L, R) | Mono, Stereo, | Mono | Usually not | No |
| | Digital Dolby, etc. | | | |
| Stereo (L, R) | Mono channel, | Stereo | Indirectly | Usually |
| | e.g., mono AM, | | | |
| | FM or TV | | | |
| Dolby Stereo (Lt Rt) | Mono channel | Mono | May have | No |
| | | | conflicting or | |
| | | | wrong indications | |
| Dolby Stereo (Lt, Rt) | Stereo channel | Dolby Pro-Logic | Possibly a brief | No |
| | | | on-screen message | |
| | | | for video programming | |
| Discrete multi-channel | Stereo channel | Stereo or Dolby | no | No |
| | | Pro-Logic depending | | |
| | | on source connection | | |
| | | to delivery channel | | |
| Stereo (L, R) | Dolby Digital 2 | Stereo | Sometimes | Sometimes |
| | channel stereo | | | |
| Stereo (Lt, Rt) | Dolby Digital 2 | Dolby Pro-Logic | Indicated | Yes, but wrong |
| | channel stereo | | incorrectly | |
| Discrete multi-channel | Dolby Digital or | Discrete multi- | Yes | Yes |
| | dts or equivalent | channel | | |

Referring to Table 2, the end user's audio reproduction equipment adds further complexity in determining the optimal configuration for audio reproduction. Even if the input audio signal from the cable system is optimized based on the source creation mechanism and the delivery channel, the user's audio reproduction equipment will also affect which configuration will provide optimal sound quality.

TABLE 2

| Audio Format | | Best mode if | Best mode if |
|---|---|---|---|
| Input to Audio | Audio | multi-channel | stereo speakers |
| Equipment | Equipment | speakers present | present |
| Mono | Stereo | Not Applicable | Mono |
| Stereo (L, R) | Stereo | Not Applicable | Stereo |
| Stereo (L, R) | Pro-Logic or | Stereo | Stereo |
| | multi-channel | | |
| | discrete | | |
| Stereo (Lt, Rt) | Stereo | Not Applicable | Stereo |
| Stereo (Lt, Rt) | Pro-Logic or | Pro-Logic | Stereo |
| | multi-channel | | |
| | discrete | | |
| Multi-channel | Multi-channel | Multi-channel | Stereo |
| discrete | discrete | | |
| Two-channel | Pro-Logic or | Pro-Logic | Stereo |
| discrete, | multi-channel | | |
| conveying Lt, Rt | discrete | | |

Note that neither Table 1 nor Table 2 contains all of the possible combinations and permutations of source creation, delivery channel, and user equipment that can affect sound quality, further illustrating the complexity of the optimization problem. Additionally, even if a given video program provides the user with an on-screen message that the program was produced with certain enhanced audio features (e.g., surround sound) that are available in certain areas, there is no way for the user to know whether the enhanced audio features are available through that particular user's cable system or other delivery system or if the user's home audio equipment is even capable of reproducing the enhanced audio signal sent through the delivery channel.

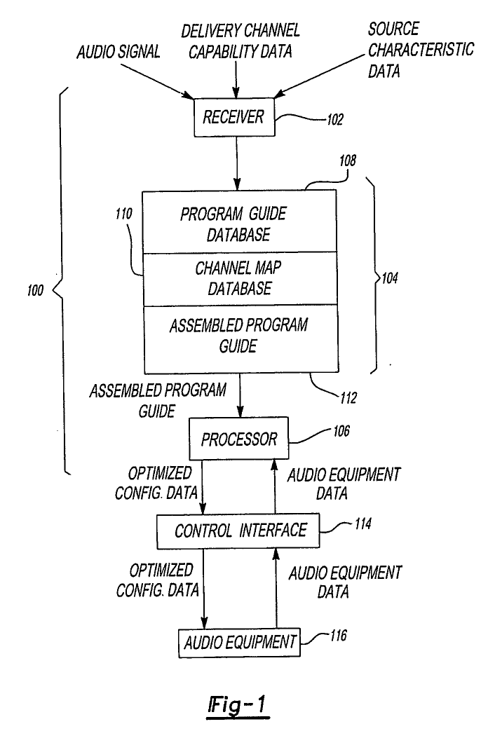

FIG. 1 illustrates one possible option for optimizing audio reproduction in the invention. More particularly, FIG. 1 illustrates a terminal 100, such as a set-top terminal, digital radio, etc., that has a receiver 102, an optional memory 104 and a processor 106. The memory 104 can have portions allocated to program guide database 108 and a channel map database 110.

A relatively simple approach for including the source characteristic data in the context of an advance analog or digital cable/satellite environment entails adding the control data to program guide data. Providing the source characteristic data in the program guide generally involves adding a parameter related to the delivery channel characteristic data to a channel map 112 used to generate the program guide. The combination of the source characteristic data with the delivery channel characteristic data describes the audio capability of each program and the optimal audio configuration for that program, given the capabilities of the local cable system.

As is known in the art, the assembled program guide 112 is a structure implemented inside, for example, a set-top terminal 100 that is used to support generation of the program guide (not shown). In one embodiment the system may need to include an additional field in the program guide database 108 for data indicating the audio format of the source program and an additional field in the channel map database 110 to indicate the minimal end-to-end capabilities of the delivery channel. Note that storage of these parameters may require more than one field, depending on the system's design, because many delivery systems include multiple delivery channels having differing capabilities.

As a specific example, the parameters added to the assembled program guide 112 may include data from the channel map database 110 describing whether the delivery channel is a digital service or an analog service, whether the analog service is only monophonic capable or also stereo capable, etc. The producer of a source program would provide the program parameters to be stored in the program guide database 108 in addition to the usual program guide information, such as the name of the program and a description of the program episode.

In practice, if the audio signal is being delivered through a digital delivery channel, the cable system will transmit the signal in, for example, Dolby Digital[R] format through the entire transmission path to the user's equipment. If the audio signal is being delivered through an analog delivery channel, however, the cable system will transmit the signal in, for example, stereo mode. Note that if the local cable system has limited audio reproduction capabilities and receives audio signals whose characteristics cannot be maintained by the local cable system's delivery channels, the channel map database 110 also contains data corresponding to the characteristics of that particular cable system and that particular channel so that the processor 106 can generate the next best configuration data taking the delivery channel's limitations into account. For example, if the program guide database indicates that a given program is recorded in stereo and the local cable system provider is unable to support stereo but can optimally support mono, the inventive system configures the user's system to listen to the program in mono.

Alternatively, the invention can be implemented by adding data fields to a Program and System Information Protocol (“PSIP”), which has been defined as part of the digital television (“DTV”) standard in the United States. In one embodiment, the data fields extend an event information table (“EIT”) in the system. By way of background, the EIT is similar to the program guide except that the EIT is a standardized way in which program guide information can be delivered. Like the program guide example described above, the data fields or data structures in the PSIP embodiment can act as a configuration guide to convey the configuration data to the receiver in the user's audio reproduction equipment for a particular channel. Note that EITs are also part of the European digital video broadcasting standard and are used to convey program guide information as well.

Unlike the program guide described above, however, the EIT is a defined party of the MPEG standard and has been included as a part of a government standard and is not proprietary to the cable service or electronic program guide provider and typically contains data only for the specific channel to which the user is tuned because each broadcaster will transmit its own EIT data for its own channel, without creating a central database containing information for all of the channels as in the case of a program guide. As a result, the memory 104 can be eliminated in this case. Because of this difference, the EIT will primarily provide information only for one given channel instead of for all of the channels received by a given subscriber.

To generate a program guide using PSIP, a DTV receiver can build an extended program guide-like function by scanning all of the available EITs and then building a program guide data base for the available services from the scanned information. More particularly, the system can tune to multiple channels in the system, collect the EIT from each channel and compile the EITs from all of the channels into a single database. Further, to obtain the most complete optimization system for a given subscriber, the data fields should be completed for all services, both analog and digital, available to a given subscriber's receiver. Note that in this embodiment, the broadcaster for each channel would place its own configuration data for its channel in the EIT. As a result, unless all broadcasters for each channel that a given subscriber receives provides the configuration data, the total amount of information provided to the receiver using the EIT may not be as complete as through the program guide embodiment described above.

The two data control options described above ensures that the processor 106 has the necessary information (i.e., the source characteristic data and delivery channel capability data) to determine the best configuration for optimal audio reproduction while taking any limitations of the delivery channel into account.

Note that if the service provider delivers optimized audio information to the user's terminal 100, however, the information does not take into account the electronic capabilities and speaker configuration of the user's home audio equipment 116. As noted above with respect to Table 2, even if the audio data is optimally configured based on the source production parameters and service provider's equipment, the actual sound that reaches the user may be less than optimal if the user's own audio equipment is not taken into account.

To address this problem, the program guide may include personalized information about the user's home audio electronics capabilities and speaker configuration. With this information, the processor 106 can then clearly indicate to the user, via an on-screen display or other indicating or annunciation system, how the user's home audio electronics should be configured for a given selected source. Although the optimal audio reproduction information can be, for example, sent to an audio or visual output mechanism showing the user how they can configure their home audio electronics for each channel they select, the burden is still on the user to conduct the actual configuration according to the information provided. Further, even if the information were made fully available to the user, the time required to manually configure the user's audio equipment according to the information may cause the user to miss a portion of the program, adding to the inconvenience. In addition, the user is required to reconfigure the audio equipment each time the service (e.g., the channel or the particular program) changes to maintain optimum audio reproduction, further adding to the user's burden.

Referring to FIG. 1, the invention may include a control interface 114 between the processor 106 and the user's audio electronics 116 to automate the configuration process. The control interface 114 acts as a data link between, for example, the processor 106 in the terminal 100 and the audio equipment 116 so that the program guide information can be used to configure the audio equipment 116 directly and also to allow the audio equipment 116 to provide information to the processor 106 for generating the configuration data. The interface 114 itself can be implemented in different ways, such as via a digital interface between the receiver and the audio equipment, an infra-red link, hard-wired connections, wireless connections, or full integration of the audio equipment 116 into the terminal 100.

A digital interface or fully-integrated audio processing circuitry provides the potential for the most complete automation in the inventive system by allowing the receiver to automatically sense which speakers and what equipment is connected to the terminal at any given time. In this type of system, the processing modes of the user's audio equipment 116 would be automatically configured and switched as the service changes, making the equipment configuration task a seamless part of program changes or changing channels. For example, when a signal containing the audio configuration information travels through the delivery channel to the terminal 100 and control interface 114, the control interface 114 automatically communicates the audio configuration information in the program guide for the selected service to the user's audio equipment 116 (e.g., audio-visual receiver, digital television, speakers, sub-woofers, etc.). The audio equipment 116 then responds to the audio configuration information and configures itself according to the information, with no manual adjustment by the user.

Specific possibilities for the control interface 114 may be as simple as jumper cables connecting different audio devices in the user's system so that commands reaching one device in the system can be relayed to the other devices through the cable. The connection itself can be designed so that devices from the same manufacturer can communicate with each other. Other interface 114 alternatives would include any interface 114 that can provide the audio configuration functionality to the audio processing electronics in the user's audio devices 116. The protocol used for the interface can be a wired protocol (e.g., IEEE 1394 or a Universal Serial Bus) or a wireless protocol. Another alternative may include extending currently know protocols, such as the Sony-Philips Digital Interface (SPDIF) protocol, to include audio configuration data for all signal and service types rather than limiting the protocol to support of configuration data in a proprietary manner for limited types of signals.

As noted above, infrared links may also be used as the control interface 114 between the processor 116 and the audio electronics 116. The infrared link can be used to, for example, sense the relative positions of the audio electronic devices 116, obtain information about the device processing capabilities, and other information that impact the optimization of the audio reproduction. Infrared links in general are already known in the art for data transmission and are used in, for example, remote controls and hand-held devices. Thus, the specific manner in which infrared links can be implemented in the inventive system is within the skill of those in the art.

Note that if the infrared link is only a one-way link (i.e., allowing communication only from the terminal 100 to the devices 116), conducting infrared control may require a calibration set-up process so that information about the audio devices 116, their processing capabilities, the number and location of speakers, etc., are entered into the program guide.

The implementation of the invention is not limited to the specific components and system described above. For example, instead of using a set-top box and a separate control interface, the invention can be incorporated into a single integrated device that contains all of the audio-visual receiver functions (e.g., the receiver, program guide, and control interface, etc.). Using an integrated system simplifies the optimization process by providing a seamless data path between the delivery channel, the receiver, the control interface, and the user's audio equipment and optimizes the audio environment accordingly.

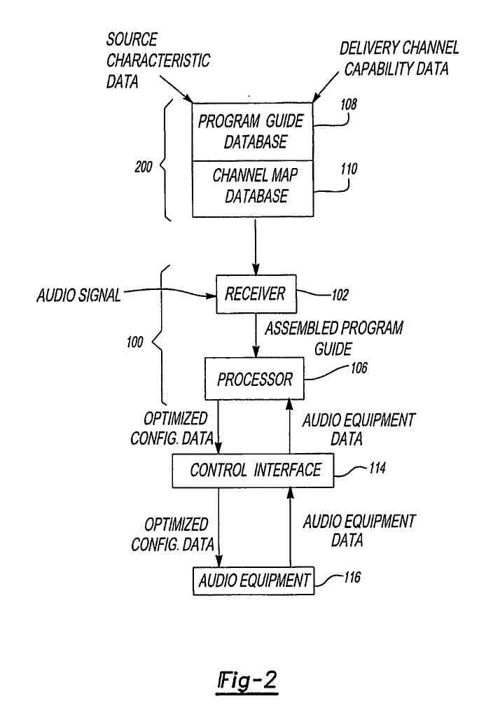

FIG. 2 shows an alternative implementation of the present invention. In this embodiment, the program guide database 108 and channel map database 110 are joined in a memory 200 that lies outside of the terminal 100. As described above, the program guide database and the channel map database contain source characteristic data and delivery channel capability data, respectively. The memory 200 can be located in, for example, the head end of the system or any other location outside of the terminal 100. In this embodiment, the program guide database 108 and the channel map database 110 may correspond to only one channel map.

In this embodiment, a partial program guide can be generated from the information in the program guide database 108 and the channel map database 110. The partial program guide is then sent to the terminal 100 along with the audio signal. The receiver 100 then generates the assembled program guide as described above and outputs the assembled program guide to the processor 106 for generating the optimized configuration data.

Application of the inventive system is not limited to the examples above, but can be used in any device and/or system that reproduces more than one audio channel as well as any system that generates or transmits an audio signal. Some examples of where the invention can be used include enhancing AM and FM stereo transmissions, BTSC/MTS (Broadcast Television Systems Committee/Multi-channel Television Sound) stereo analog transmissions, cable and satellite transmissions, CDs, DVDs, internet audio, etc. and the source mastering for the transmission media. For example, in view of ongoing efforts to transition from analog AM and FM transmissions to standardized digital broadcast signals, the same optimization techniques described above can be applied to the digital transmissions (e.g., by transmitting the configuration data long with the digital audio data). Additionally, the invention can be incorporated into CD's and DVD's, which already contain digital data and have space available for other data; in this application, the audio configuration data, its location and format on the disk, and the specific control interface implementation would need to be determined and standardized through known methods.

The configuration data itself can take any form that is accessible by the delivery channel, control interface, and audio equipment to provide the necessary information for optimizing audio reproduction. As explained above, the configuration data can be included in additional fields in program guide data or in an event information table. Another option is to include the configuration data as metadata in formats that provide locations for storing metadata. Metadata is generally defined as any data that is related to a program but is not the program itself, such as information about the production environment and acoustical space, dialog level, dynamic range information, intellectual property rights, etc. Note that if a particular format provides metadata that includes many different information fields, the program guide data and/or event information table can be enhanced to include as much information as the format providing the metadata, thereby providing the option of extended information for all services delivered through the system, whether or not its format specifically includes the extended metadata. Thus, even existing program content can be modified according to the invention so that it contains as much information as program content that is generated with the metadata in the first place. Further, the invention makes the metadata and/or the extended information available to all devices along the signal transmission chain so that the devices can respond to the information and optimize the audio reproduction environment accordingly.

As a result, the present invention allows home theatre equipment to receive audio data and automatically configure the equipment to optimize audio reproduction and ensure that the sound is reproduced in the best possible manner based on the audio data's parameters as well as the capabilities/limitations of the data delivery channel and the user's own equipment. The invention creates a “plug-and-play” system that can provide the end user with the best possible audio reproduction by automatically detecting information regarding the audio source and delivery channel, determining the optimal equipment configuration in view of the limitations of the delivery channel and equipment, and automatically configuring the system based on this information. Because the configuration is automatic, the inventive system optimizes sound reproduction without requiring any action or any specialized knowledge on the part of the user.

Further, the present invention takes advantage of available data fields in digital carriers of audio information by ensuring that these data fields contain audio production information and that the information is maintained throughout the distribution channels so that a user's home audio equipment can respond to the information. The invention also provides a defined mechanism to describe audio parameters for analog recordings and analog distribution mechanisms. Although the above examples specified various specific delivery channels, the invention can be applied to any delivery channel, including but not limited to television broadcasts, radio broadcasts, satellite or other wireless delivery, DSL (which includes all variants, such as ADSL and XDSL) delivery, Internet delivery, and cable delivery. The invention can also be used for any audio source, such as audio CDs, digital television programs, and DVDs.

As a result, the invention proposes providing sufficient data in the data fields to allow fully automated control and optimization of the listener's environment, without any knowledge or input required from the user.

While the invention has been specifically described in connection with certain specific embodiments thereof, it is to be understood that this is by way of illustration and not of limitation, and the scope of the appended claims should be construed as broadly as the prior art will permit.

1. A terminal for optimizing reproduction of an audio signal that has source characteristic data and that is transmitted through a delivery channel, comprising:
a receiver that receives the audio signal, the source characteristic data, and delivery channel capability data via at least one data field associated with the delivery channel; and
a processor that generates optimized configuration data for reproducing the audio signal based on the source characteristic data and the delivery channel capability data.

2. The terminal of claim 1, wherein said at least one data field is added to a Program and System Information Protocol.

3. The terminal of claim 1, wherein said at least one data field is added to an Event Information Table associated with the delivery channel.

4. The terminal of claim 3, wherein at least one of at least two delivery channels capable of sending the audio signal to the terminal has the Event Information Table.

5. The terminal of claim 4, wherein a given Event Information Table is associated with one of said at least two delivery channels.

6. The terminal of claim 4, wherein the processor generates a program guide from the Event Information Table associated with said at least two delivery channels.

7. The terminal of claim 1, wherein the optimized configuration data generated by the processor includes data that provides an alternative configuration if the delivery channel cannot support the source characteristic of the audio signal.

8. The terminal of claim 1, wherein said at least one data field is included in a recording medium containing audio data for generating the audio signal.

9. The terminal of claim 1, wherein the delivery channel is at least one selected from the group consisting of a television broadcast, radio broadcast, satellite delivery channel, wireless delivery channel, DSL delivery channel, Internet delivery channel, and cable delivery channel.

10. The terminal of claim 1, wherein said at least one data field is at least one metadata field.

11. The terminal of claim 1, further comprising a control interface that couples the terminal with audio equipment.

12. The terminal of claim 11, wherein the control interface is one selected from the group of hard wired connection, a wireless link, or an integrally formed connection with the terminal.

13. The terminal of claim 12, wherein audio equipment data from the audio equipment is transmitted through the control interface to the terminal and wherein the processor generates the optimized configuration data based on the audio equipment data.

14. The terminal of claim 13, wherein the control interface transmits the optimized configuration data is transmitted through the control interface to the audio equipment to configure the audio equipment based on the optimized configuration data.

15. The terminal of claim 13, wherein optimized configuration data is transmitted through the control interface to the audio equipment to configure the audio equipment based on the optimized configuration data.

16. The terminal of claim 1, wherein the receiver further receives a partial program guide generated from a program guide database and a channel map database outside of the terminal.

17. The terminal of claim 16, wherein the terminal generates an assembled program guide based on the data in the program guide database and the channel map database.

18. A system for optimizing reproduction of an audio signal that has source characteristic data and that is transmitted through at least one of a plurality of delivery channels, comprising:
a receiver that receives the audio signal and the source characteristic data;
a channel map database that contains delivery channel capability data for at least one each of said plurality of delivery channels;
a program guide database that stores the source characteristic data;
a control interface that couples the terminal with audio equipment to allow audio equipment data to be transmitted to the terminal; and
a processor that generates optimized configuration data for reproducing the audio signal based on the source characteristic data, the delivery channel capability data, and the audio equipment data.

19. The system of claim 18, wherein the receiver, program guide database and the channel map database and processor are disposed in a terminal.

20. The system of claim 18, wherein the program guide database and the channel map database are disposed in a memory that is in a head-end portion of the system.

21. The system of claim 18, wherein the optimized configuration data generated by the processor includes automatic configuration information that is transmitted to the audio equipment via the control interface.

22. The system of claim 18, wherein the memory further comprises a channel map that generates a program guide based on the data in the program guide database and the channel map database.

23. The system of claim 18, wherein the optimized configuration data generated by the processor includes data that provides an alternative configuration if the delivery channel cannot support the source characteristic of the audio signal.

24. The system of claim 18, further comprising an output interface that couples the processor to an output mechanism for outputting the optimized configuration data to a user.

25. The system of claim 18, wherein the control interface is one selected from the group of a hard wired connection, a wireless link, or a integrally formed connection with the terminal.
